(19) United States
(12) Patent Application Publication
(10) Pub. No.: US 2011/0169326 A1
(43) Pub. Date: Jul. 14, 2011

(54) Method and apparatus for distributing powerline communications signals

(76) Inventor: Oleg Logvinov, East Brunswick, NJ (US)

(21) Appl. No.: 12/657,065

(22) Filed: Jan. 13, 2010

(51) Int. Cl. H04B 3/54

(52) U.S. Cl. 307/1

(57) ABSTRACT

A system for using Powerline Communications (PLC) as a means to solve various flat wire limitations. The PLC modem connects to the electrical power line and can communicate with devices on the powerline network. The PLC data is then coupled to the flat wire, which conducts the data to the end device. Encoding/decoding of the PLC data can be done either at the electrical power interface or at the device end of the flat wire.

### FIELD OF THE INVENTION

This invention is directed to a method and apparatus for distributing powerline communications between the electric wires and flat wire that can be mounted to the surface of a wall or the device.

### BACKGROUND OF THE INVENTION

The home, office, and other venues are becoming increasingly filled with various electronic communication systems, with both wired and wireless communication network installations growing significantly. Wireless communications methods may be used where running wires is difficult (such as through walls) and where communications distances are small and free of RF obstructions. They also provide a means to avoid most of the unattractive bundles of wire that connect components of systems, such as speakers, displays, controls, and content source devices. Unfortunately, RF transmitters can not power the device to which it is linked. Flat wire permits the distribution of power and/or communications signals to system components over the surface of a wall or the device itself. Examples of flat wire that are currently known in the art, and includes, for example FlatWire Ready® products by Flatwire Technologies, a division of Southwire, and whose disclosure is herein incorporated by reference. This flat wire may be hidden under wallpaper, plastered over, or use other means to hide its presence. Because flat wire is designed to be hidden, it shares the advantage with RF of not having the visual drawbacks of conventional wires and cables.

To date, flat wire is used to distribute power from the AC lines or audio signals from local sources such as a CD player. Both signal and power are not distributed at the same time. The flat wire has to be connected to a junction box, which is in turn wired to the signal source. The flat wire is attached to the surface of a wall, for example, and to another junction where the flat wire is physically adapted to the destination device, such as a light or a speaker. The application of flat wire is limited to the immediate room because is it not rated for through-wall installations. It is also subject to restrictions that may be caused by floor-to-ceiling windows, doors and surfaces not supportive of flat wire. In addition, flat wire is point-to-point, and does not provide a means to minimize the length of the wire. The invention provides a way to solve these problems using existing electrical wiring.

### SUMMARY OF THE INVENTION

The invention provides solutions for the aforementioned problems associated with the application of flat wire technology. By routing flat wire to the nearest AC outlet and using Powerline Communications (PLC) network techniques, that are well known in the art, these problems related to the length of the wire run, wiring between rooms, and avoiding obstructions can be solved. It also allows data and power to be distributed over the same set of flat wires, thereby reducing the number of wire assemblies needed, and consequently, the cost, as well as increasing the number of useful applications.

### DESCRIPTION OF THE DRAWINGS

FIG. 1 illustrates an example of a typical flat wire installation for an audio speaker using a plug-over connection method.

FIG. 2 illustrates an example of and audio installation using PLC and flat wire using a plug-over connection method.

FIG. 3 illustrates an example of a home audio control keypad connected by flat wire to a PLC network.

### DETAILED DESCRIPTION

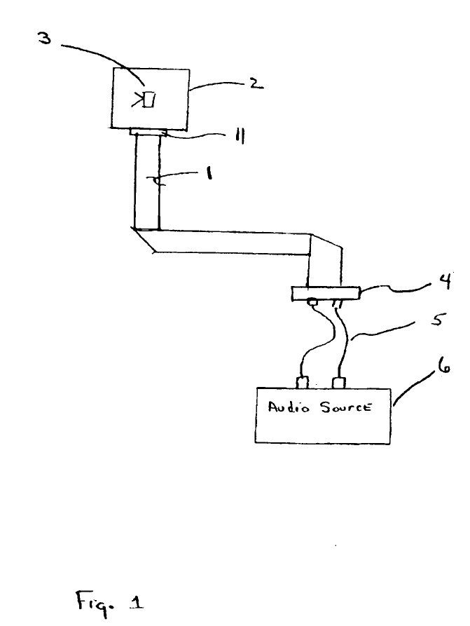

FIG. 1 shows a flat wire 1 as currently used to distribute power or audio to an end device 2. This end device may be a variety of different devices commonly used in homes, offices and industry, but is most often a light(s) or a speaker(s) 3 as shown in FIG. 1 or light(s). In current flat wire applications, the wires are not allowed to be passed through walls (between rooms) for practical and safety reasons. This limits the distance that devices can be connected by flat wire. A secondary cable and/or connection 5 would be required to connect audio or power sources 6 to the flat wire 1 connected to the end device 2. This connection is made in a junction box 4 that was designed for the appropriate connectors and flat wire. Examples of these products and installations are available from FlatWire Ready®, a division of Southwire.

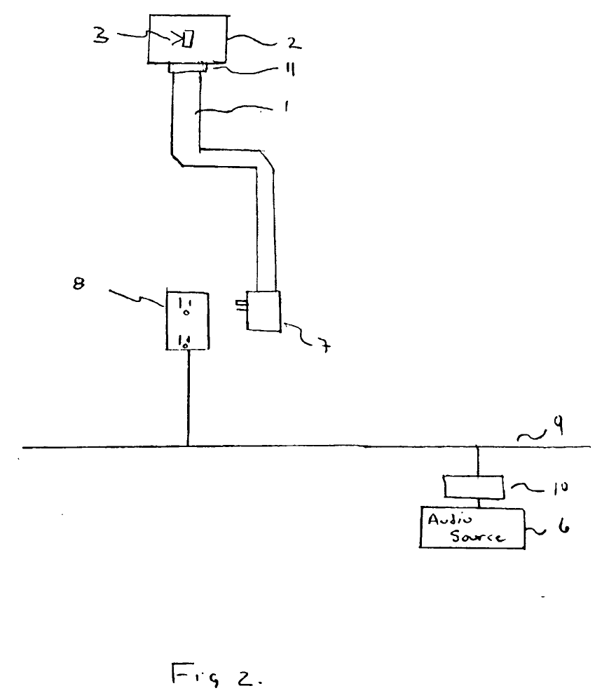

This problem is solved in FIG. 2 by the introduction of Powerline Communications (PLC). The Powerline communications modem 7 provides a network capability to the flat wire installation. This capability is a new feature in the application of flat wire installations and the combination of both provide a new class of products.

One embodiment of this solution is illustrated in FIG. 2 as a novel improvement of FIG. 1. In this example, an audio source 6 does not have to be near the end device 2. Instead, audio source 6 is coupled to the electric power line from a power line communications modem 10 which may be internal or external to the audio source 6, to another power line communications modem 7 located near the end point. This latter power line communications modem 7 distributes the data or signals to the flat wire 1 for distribution to the end point 2. The audio source 6 can, therefore be, for example, in any room of the house and does not require special audio cables 5 such as RCA audio cables, to bring the audio content into the same room as the end point 2. In this embodiment, the powerline modem adapter uses a protocol, several of which (such as HomePlug AV and HomePlug Command and Control) are already in the art and whose disclosure is herein incorporated by reference.

The powerline modem adapter may be implemented in a variety of ways. The preferred embodiment is a “plug-over” method wherein the module contains at least the necessary powerline communications electronics including a processor, memory, AC/DC power supply, analog front end, power line interface, and the physical connections to the flat wire which usually requires a special connection means due its physical nature. It also contains a standard low voltage plug that is used to plug into the standard electrical power receptacle 8. This is referred to as “plug-over”, because it plugs over and covers at least one of the receptacles 8 and the name will distinguish it from other embodiments. In an alternate embodiment, the powerline communications modem may be embedded in the electrical junction box in place of the receptacle 8 so it is less pronounced. In this case the electrical plug on the power line communications module would be replaced with terminals for direct connection to the electrical power wires 9. In this embodiment, the module may also consist of additional AC plugs (not shown) so that other AC devices may derive electrical power by plugging into the power line communications module.

The power line communications modem may also be located at the end point junction box or housing if the electrical power is distributed to the end point by the flat wire.

In most cases, the module will also consist of any special circuits required by the end point application. For example, if the end point is a speaker, the powerline communications module may also contain an audio power amplifier. An intercom or home audio system keypad 20 may require an additional communications interface or supply voltages.

In another embodiment, the content may be video, video and audio, control signals, timing signals, or any combination thereof.

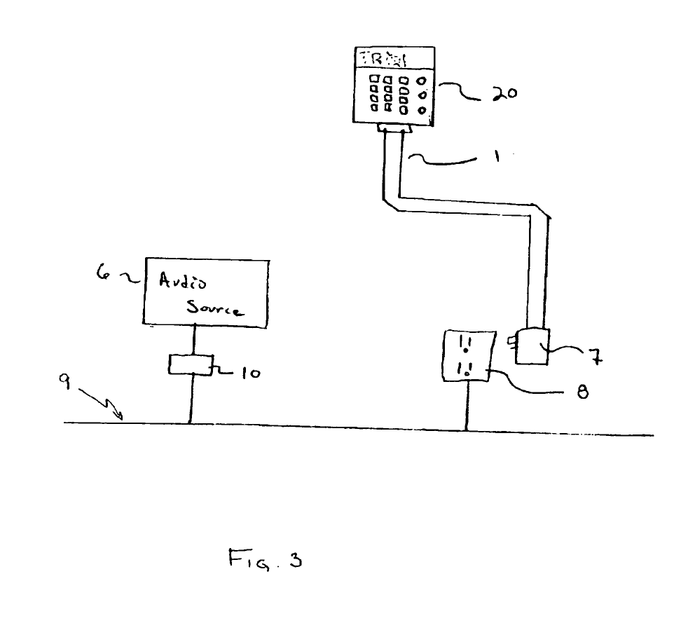

In another embodiment, shown in FIG. 3, a controller 20 for a home audio system is connected as the end device of a flat wire system. The control panel controls the audio source 6 regardless of where the audio source 6 is located. The controller may also control security systems, security cameras, and other devices that may be on the powerline communications network 9 or are endpoints. These examples are not intended to limit the number of possible applications and other embodiments may be created from the combination of power line communications with flat wire.

What is claimed is:

1. A communication system comprising:
a connection between an electric power line and a power line communications modem containing a processor, memory, AC/DC power supply, analog front end, and power line interface capable of transmitting or receiving content, timing and or control signals.
a connection between a powerline communications modem and a flat wire,
and a connection between the flat wire and an end device.

2. A communication system according to claim 1, wherein the powerline communications modem is connected to the power line by plugging a PLC modem adapter into a wall receptacle.

3. A communications system according to 1, wherein the powerline communications modem is located inside the electrical power junction box and is connected to the power line by direct connection to the electric power cable.

4. A communications system according to 1, wherein the power line modem is located at the end point side of the flat wire.
